(19) United States
(12) Patent Application Publication
(10) Pub. No.: US 2006/0236466 A1
(43) Pub. Date: Oct. 26, 2006

(54) Effectively printable polymide yarn, process for making the same, and fabric produced therefrom

(76) Inventors: Perry Han-Cheng Lin, CANTON, GA (US); Nitin J. Champaneria, Seaford, DE (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(21) Appl. No.: 10/544,037

(22) PCT Filed: Feb. 6, 2004
(86) PCT No.: PCT/US04/03528

§ 371 Date: Apr. 11, 2006

Related U.S. Application Data
(60) Provisional application No. 60/445,354, filed on Feb. 6, 2003.

(51) Int. Cl. C11D 3/00

(52) U.S. Cl. 8/115.51

(57) ABSTRACT

A method of manufacture of a rapid dyeing, deep dyeing, open structure polyamide yarn and to the yarn and to a fabric produced from the yarn includes the step of applying an aqueous finish to substantially all of the rapid dyeing, deep dyeing, open structure polyamide filaments. The aqueous finish consists essentially of a fluorosurfactant dissolved in water that is applied to bulked continuous filament yarn at an effective concentration level of preferably 150 to 600 parts per million by weight of flourine on yarn. The aqueous fluorosurfactant finish is applied at a point after texturizing and before windup.

### FIELD OF THE INVENTION

The subject invention is a process to make yarns that when incorporated into textiles and tufted fabrics create excellent substrates for printing.

### BACKGROUND OF THE INVENTION

It has long been an object of the textile industry to create fabrics having intricate patterns of distinct colors. In recent years improved printers and inks have markedly increased the potential for design variety in many fabric substrates. Textiles of polyamide fibers, including tufted goods, are challenging substrates for printing. While a wide variety of dyes can be applied to polyamides, sharp print definition is more difficult. Dye formulations that work well for dyeing fabrics in bulk tend to smear together on untreated nylon fabrics, especially at the elevated temperatures needed to fix such dyes. Irregularities of surface coatings on the fabric also result in non-uniform dye uptake. The non-uniform surface structure of polyamides can also make it difficult to obtain uniformly complete dye absorption with the limited amount of dye that can be applied in a print spray.

In the past, nylon fabrics (e.g., carpets) have required special treatment with various surface-active agents such as fluorinated organic polymers prior to printing in order to achieve acceptable print quality. U.S. Pat. No. 4,231,744 (Russell et al.) and U.S. Pat. No. 4,256,459 (Moot) are representative of such technology. Such fluoropolymer materials are known to have low surface energy and it might be inferred that their mechanism of action in fabric dyeing is to reduce the contact angle between the dye drops and the fabric, and so prevent the dye from running before it can be absorbed by the fabric. As a result the dye pattern spreads less on the fabric surface.

In addition to fluorinated organic chemicals, other chemicals such as silicones having similar surface-active properties have also been found to improve print definition when applied to other substrates, such as paper.

Low surface energy chemicals for such fabric treatments are generally not very water-soluble, and do not necessarily coat the exposed fabrics uniformly, so they are normally formulated as dispersions and emulsions. Methods such as “padding” may be used to apply surface modification agents, but such low cost methods are incapable of coating the fabric with sufficient uniformity, so print quality is limited. Surface modification chemicals may also be applied via treatment baths, but this tends to raise processing cost. The high cost of fluorinated chemicals, the need for additional processing equipment and the requirement to maintain consistency with the rest of the dyeing and finishing process are all disadvantages of treatment bath addition. A further disadvantage of treatment bath application is the issue of additional waste disposal volume.

While it would seem to be desirable to provide a yarn with low surface energy for printing, this has proven to be difficult to accomplish. The fluorinated polymeric materials that have been used thus far to improve fabric printing are generally incompatible with spinning and yarn processing. One reason for this is the high yarn-metal friction occurs with fluorinated polymers, and if applied in spinning, water insoluble fluoropolymeric species tend to accumulate on the exposed surfaces of spinning and processing equipment leading to yarn breakage and staining, frequent shutdowns for cleanup, and substantially reduced process yield.

In addition to the above process problems, the addition of polymeric chemicals to spin finishes also causes reduced coating uniformity and thus reduces printing uniformity. Where the coating is too thick, dye may be poorly absorbed, while incomplete coatings cause poor print definition and clarity. Uniform finish application in spinning is naturally impossible if the finish emulsion accumulates on the yarn contact surfaces, breaks down into its individual components, or is incompatible with the properties of other finishes that are required to operate the spinning process. All of these problems occur with suspensions and emulsions of insoluble fluorochemicals, which is why they have generally not been successfully applied in spinning.

As described above, a secondary problem with polyamide print quality relates to depth and rate of dye absorption. The more completely the fabric takes up the dye, the deeper the color. The faster it reacts, the better the final print image sharpness. These properties are not perfectly compatible, as deeper dyeing polymers may take longer to achieve dye exhaustion. So far, polyamide fibers used in printing have been a compromise of properties in terms of dye depth and dye rate, and they have required pretreatment of the fabric before printing.

In view of the foregoing it is believed to be desirable to provide a printing yarn having properties such that, after conversion to fabric, it could, without a chemical coating pretreatment, accept very small drops of ink or dye and absorb them quickly, deeply and uniformly, so that the fabric would become permanently dyed in the pattern that the dye drops were applied with the least possible running and smearing of the drops. It would be especially desirable that the yarn accepts dye in sufficient quantity to provide deep, rich colors.

### SUMMARY OF THE INVENTION

The present invention is directed to a method of manufacture of a rapid dyeing, deep dyeing, open structure polyamide yarn and to the yarn and to a fabric produced from the yarn. The polyamide yarn produced by the method can be printed directly as yarn, or after being made into a fabric, without the requirement for additional pretreatment coating chemicals to achieve acceptable print image definition. The yarn of the subject invention is formed from a polyamide polymer having amine ends sufficient to accept deep acid dye colors and having polymer modifiers such that the yarn maintains a relatively open surface structure through the process of spinning, air quenching, drawing and bulk texturing such that the subject yarn reacts quickly with dye. The present invention further involves the process of treating the subject yarn filaments prior to winding with an aqueous fluorinated surfactant solution in a separate finish application step. The aqueous finish applied in accordance with the present invention consists essentially of a fluorosurfactant at an effective concentration level of at least 150 parts per million by weight of flourine on yarn, and preferably 150 to 1000 parts per million by weight of flourine on yarn, and more preferably 150 to 600 parts per million by weight of flourine on yarn. The aqueous fluorosurfactant finish is applied in an enclosed chamber at a point in the yarn production process after texturizing and before windup.

### BRIEF DESCRIPTION OF THE DRAWINGS

The invention will be more fully understood from the following detailed description taken in connection with the accompanying drawings, which form a part of this application and in which:

FIG. 1 is a schematic illustration of a spinning and drawing process for forming a multi-filament bulked continuous filament yarn in accordance with the present invention;

FIG. 2 is an enlarged view of the finish applicator used in the process illustrated in FIG. 1.

### DETAILED DESCRIPTION OF THE INVENTION

Throughout the following detailed description similar reference numerals refer to similar elements in all figures of the drawings.

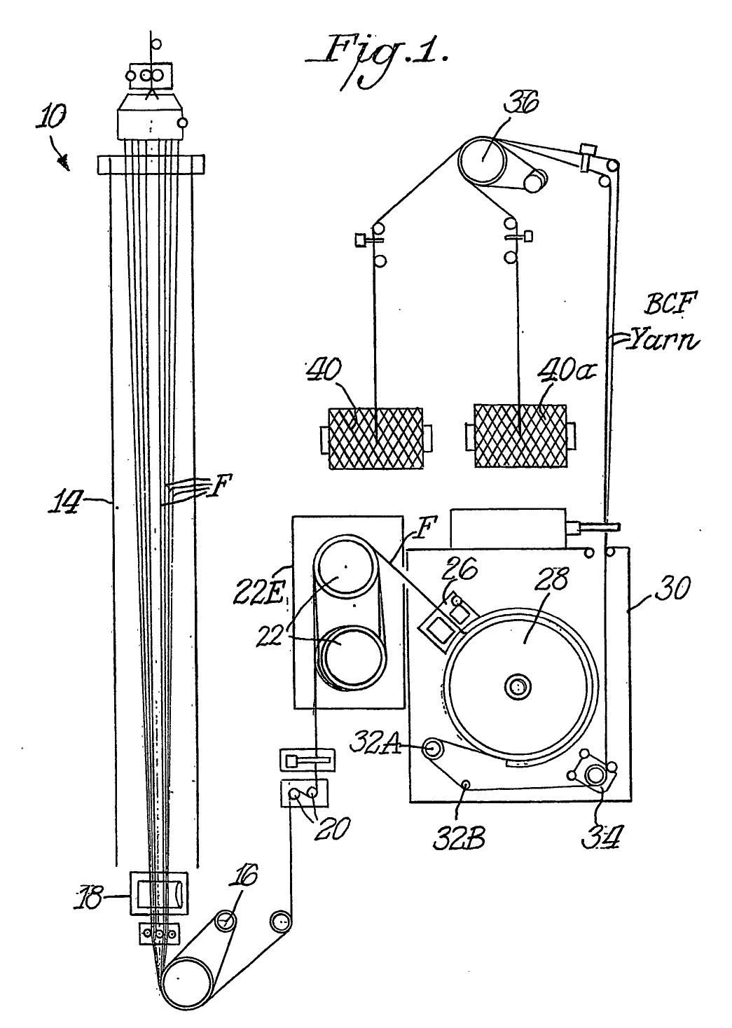

With reference to FIG. 1 shown is a schematic illustration of a spinning and drawing process for forming a multi-filament effectively printable bulked continuous filament polyamide yarn in accordance with the present invention.

A polyamide flake rich in amine ends and modified as needed to assure other desired properties is melted and extruded through a spinneret 10 to form filaments F. In the case of making a printable BCF yarn for use in flooring or furnishings the preferred polymer, from the standpoint of durability, resilience, stain resistance and resistance to attack from UV and ozone exposure, is Nylon 66, a polymer of adipic acid and hexamethylenediamine. Such Nylon 66 homopolymer, however, does not dye deeply enough, rapidly enough, to be used effectively in the present invention. Instead, a polymer of adipic acid and hexamethylenediamine, modified with 1-methyl-pentamethylenediamine and terephthalic and/or isophthalic acid, herein afterwards described as a “terpolymer” of Nylon 66, has the most advantageous combination of rapid and deep dyeing characteristics, while still maintaining the essential advantages of Nylon 66. The preferred polymer is a Nylon 66 terpolymer containing about 42.9% hexamethylenediamine, 47.0% adipic acid, 2.7% terephthalic acid and 7.4% methylpentamethylenediamine. The preparation of such a Nylon 66 terpolymer is disclosed U.S. Pat. No. 5,378,800 (Mok et al.), assigned to the assignee of the present invention.

The reason for the advantageous properties of the above polymer composition with respect to printing is believed to be the compatible but irregular monomer structures included in the described terpolymer which may serve to provide an “open structure” on the fiber surface, suitable for rapid and deep dyeing. Somewhat less advantageous properties may be generally be found in applying the present invention to yarns spun from other amine-end rich polyamides, including Nylon 6 (poly-iminocarbonylpentamethylene) that has been chemically modified to increase the availability of free amine ends, either by end capping of acid ends or by the addition of dyeable amine ends, or both, by such means as are known to one skilled in the art, and Nylon 66 polymers modified with caprolactam and/or other compatible but “irregular” monomers which are known in the art.

The openings in the spinneret 10 can take any convenient or desired shape, thereby to impart any predetermined cross section configuration to the filaments F. The filaments F are air-quenched in a chimney 14 wherein cooling air at a predetermined temperature is blown at a predetermined flow rate past the filaments F. The filaments F forming a yarn bundle are pulled from the spinneret and through the quench zone by one (or more) feed roll(s) 16 rotating at a predetermined rotational speed.

At the bottom of the chimney the filaments pass through a finish position 18 where the filaments F are coated with a primary finish to facilitate drawing and texturing. The finish may be applied using any of the devices commonly known in the art as finish applicators, such as finish rolls or finish applicator tips.

The filaments F next pass around the feed roll 16 and are drawn over a pair of heated draw pins 20 by a pair of heated draw rolls 22. An insulated enclosure 22E reduces the loss of heat energy from the draw rolls 22. As is known in the art additional draw rolls may be provided if a multi-step draw is desired.

After draw the filaments F are textured and form a coherent, rapid dyeing, open structure bulked continuous filament (BCF) polyamide yarn. Texturing may be accomplished by passing the filaments through the combination of a bulking jet 26 and rotating perforated drum 28 with mist quench. Alternatively, the filaments may be textured using stuffer jets (not shown), as is widely practiced in the art. In the subject process the texturizing elements are housed within a heat retaining enclosure 30. After texturizing the filaments of the resulting yarn are advanced by take up roll 36 and then pass to a winder 36 that forms the yarn into packages 40, 40a.

In accordance with the present invention immediately after texturizing the combined filaments of the yarn undergo a change in direction around members 32A, 32B and then pass through a finish applicator 34 also disposed within the heat retaining enclosure 30. The yarn direction again is changed by the finish applicator and directed toward the take-up 36.

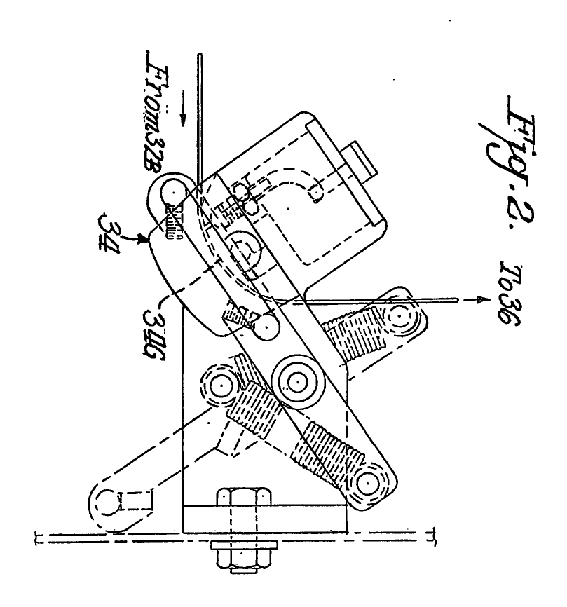

The applicator 34, seen in more detail in FIG. 2, has a groove 34G formed therein. As the yarn wraps along the base of the groove 34G an aqueous fluorosurfactant finish is applied. The wrap angle of the filaments of the yarn around the applicator 34 must be sufficient to maintain the yarn in operative finish-receiving contact with the applicator. In the design shown the applicator should be positioned such that the wrap angle should be at least two hundred degrees and, preferably, about two hundred seventy degrees, to be effective in applying finish to the filaments of the yarn.

As seen from FIG. 1 the applicator 34 is disposed within the heat retaining enclosure 30. Because the temperature at this region of application is about eighty to one hundred degrees Centigrade, it would not be usual to apply a spin finish at this location, as spin finishes are usually temperature sensitive emulsions. Surprisingly, the disclosed location has been found to be especially well suited to the application of the dilute fluorosurfactant solution in accordance with the present invention. The location of the applicator 34 (i.e., within the enclosure 30 at a change in direction point) is believed especially advantageous location to apply the secondary finish of the present invention. This location immediately after bulking is conducive to thorough and highly uniform application of the finish to each of the individual yarn filaments, while excess moisture is naturally removed and any aerosolized fluorosurfactant from the yarn is easily contained. By applying the fluorosurfactant to the filaments within the enclosure 30 any finish material that evolves into mist or becomes. airborne is confined within the enclosure and its release to the operating environment can be prevented. Because the fluorosurfactant finish of the present invention is a solution of two components, fluorosurfactant and water, and not an emulsion, it is inherently heat stable. As may be fully understood by one skilled in the art, the aqueous fluorosurfactant secondary finish of the present invention may also be applied at alternative enclosed and vented locations anywhere after the heated drawing rolls, preferably after the bulk texturing step, of the yarn spinning process.

As described above, the secondary finish of the subject invention is a dilute aqueous dispersion of a fluorosurfactant. Preferably the dispersion, containing about 0.1 to 10%, and more preferably, 1 to 3% fluorosurfactant in water, is used at the appropriate application rate to provide an effective concentration level of at least 150 parts per million by weight of flourine on yarn, and preferably 150 to 1000 parts per million by weight of flourine on yarn, and more preferably 150 to 600 parts per million by weight of flourine on yarn.

The fluorosurfactant used in the present invention is a polar chemical having both substantial perfluourinated organic functionality and any of cationic, anionic or amphoteric functionality, and having a water solubility greater than about ten percent (10%) and preferably greater than about twenty-five percent (25%) by weight. The fluorosurfactant having anionic functionality sold by E. I. Du Pont de Nemours and Company as Zonyl® FSP is preferred.

The yarn of the subject invention is found to be an effectively printable yarn that accepts very small drops of ink or dye and absorbs them quickly, deeply and uniformly. Fabrics constructed of such yarn has been shown to maintain these advantageous properties. These properties are achieved for both the yarn and the fabric without the requirement of treatment with a fluoropolymer species, and so avoid the attendant disadvantages as described above.

What is claimed is:

1. A method for producing an effectively printable polyamide yarn comprising the steps of:
a) spinning a modified polyamide polymer to form rapid dyeing, deep dyeing, open structure polyamide filaments;
b) quenching the filaments so formed;
c) drawing the filaments;
d) texturizing the drawn filaments; and thereafter
e) winding the texturized filaments into a package,
wherein the improvement comprises:
applying to substantially all of the rapid, dyeing, deep dyeing, open structure polyamide filaments an aqueous finish consisting essentially of a fluorosurfactant at a point after texturizing and before windup.

2. The method of claim 1 wherein the aqueous finish has a concentration level of at least 150 parts per million by weight of flourine on yarn.

3. The method of claim 1 wherein the aqueous finish has a concentration level of 150 to 1000 parts per million by weight of flourine on yarn.

4. The method of claim 1 wherein the aqueous finish has a concentration level of 150 to 600 parts per million by weight of flourine on yarn.

5. The method of claim 1 wherein the fluorosurfactant is a polar chemical having both substantial perfluorinated organic functionality and any of cationic, anionic or amphoteric functionality, and has a water solubility greater than about ten percent (10%) by weight.

6. The method of claim 1 wherein the fluorosurfactant is a polar chemical having both substantial perfluorinated organic functionality and any of cationic, anionic or amphoteric functionality, and has a water solubility greater than about twenty-five percent (25%) by weight.

7. The method of claim 1 wherein the fluorosurfactant is a polar chemical having both substantial perfluorinated organic functionality and amphoteric functionality, and has a water solubility greater than about ten percent (10%) by weight.

8. The method of claim 1 wherein the fluorosurfactant is a polar chemical having both substantial perfluorinated organic functionality and amphoteric functionality, and has a water solubility greater than about twenty-five percent (25%) by weight.

9. The method of claim 6 wherein the aqueous fluorosurfactant finish is applied to the filaments within an enclosed chamber.

10. The method of claim 5 wherein the aqueous fluorosurfactant finish is applied to the filaments within an enclosed chamber.

11. The method of claim 4 wherein the aqueous fluorosurfactant finish is applied to the filaments within an enclosed chamber.

12. The method of claim 3 wherein the aqueous fluorosurfactant finish is applied to the filaments within an enclosed chamber.

13. The method of claim 2 wherein the aqueous fluorosurfactant finish is applied to the filaments within an enclosed chamber.

14. The method of claim 1 wherein the aqueous fluorosurfactant finish is applied to the filaments within an enclosed chamber.

15. A rapid dyeing, deep dyeing, open structure polyamide yarn having thereon a coating consisting essentially of a fluorosurfactant at an effective concentration level of at least 150 parts per million by weight of flourine,
thereby to form an effectively printable polyamide yarn.

16. The yarn of claim 15 wherein the aqueous finish has a concentration level of 150 to 1000 parts per million by weight of flourine on yarn.

17. The yarn of claim 15 wherein the fluorosurfactant is a polar chemical having both substantial perfluorinated organic functionality and amphoteric functionality, and has a water solubility greater than about ten percent (10%) by weight.

18. An effectively printable polyamide fabric including a rapid dyeing, deep dyeing, open structure polyamide yarn having thereon a coating consisting essentially of a fluorosurfactant at an effective concentration level of at least 150 parts per million by weight of flourine on yarn, the fabric being free of fluoropolymer species.

19. The fabric of claim 18 wherein the aqueous finish has a concentration level of 150 to 600 parts per million by weight of flourine on yarn.

20. The fabric of claim 18 wherein the fluorosurfactant is a polar chemical having both substantial perfluorinated organic functionality and amphoteric functionality, and has a water solubility greater than about ten percent (10%) by weight.
